(19) United States
(12) Patent Application Publication
(10) Pub. No.: US 2024/0251815 A1
(43) Pub. Date: Aug. 1, 2024

(54) CHEESE EQUIVALENT PRODUCED ON THE BASIS OF PROTEINS OF PLANT ORIGIN

(71) Applicant: ROQUETTE FRERES, Lestrem (FR)

(72) Inventors: Elsa MULLER, BETHUNE (FR); Clément DAVID, BETHUNE (FR); John SANDOU, MEAUX (FR)

(21) Appl. No.: 18/561,209

(22) PCT Filed: May 17, 2022
(86) PCT No.: PCT/FR2022/050937

§ 371 Date: Nov. 15, 2023

(30) Foreign Application Priority Data
May 17, 2021 (FR) FR2105105

(51) Int. Cl. A23C 20/02

(52) U.S. Cl. CPC A23C 20/025

(57) ABSTRACT

The invention relates to a method for producing a legume-based soft cheese equivalent, to the use of a legume-based liquid composition for preparing a soft cheese equivalent and to a soft cheese equivalent.

### TECHNICAL FIELD

The invention relates to a method for obtaining a soft cheese equivalent as an alternative to traditional dairy cheeses.

### PRIOR ART

The vegetarian and vegan food market is experiencing notable growth and the number of people who, for various reasons, are either required to or choose to eat exclusively vegetarian food is constantly increasing. Products on the basis of plant proteins can also be particularly important for people who are allergic to animal milk proteins or who cannot digest cholesterol or lactose, or for diabetic persons. For example, soy proteins can also be much easier to digest than animal milk proteins by people who suffer from stomach and intestinal diseases. As part of the process to vegeterianize products on the market and reduce costs, it may be proposed to develop novel solutions on the basis of plant proteins to make it possible to find an alternative to milk proteins.

A certain number of plant-based cheese equivalents already exist. In most cases, these are products formulated to obtain a cheese-like texture without using the fermentation processes conventionally used in cheese-making. As regards pressed cheese products, these are generally an emulsion of water, vegetable fat, starch and other hydrocolloids and flavors, the vast majority of which are intended to be melted. Also, there are few fermented products of the soft cheese type.

A method for producing food products from fermented soy milk is known from document FR2738991, in which the soy milk undergoes lactic and/or propionic fermentations. Document US2017347677 describes a method for producing a cheese-based food product, especially a cheese, a cheese specialty or a cheese substitute. In the case of the latter, it is obtained through a retentate resulting from a technique for filtering a plant juice and wherein, especially, at least part of the proteins of the plant juice are retained. However, the method disclosed in this document remains difficult to implement because it requires, on the one hand, providing a texturing composition and, on the other hand, providing a flavor composition. Document DE 37 30 384 describes a known method for using soy milk to manufacture a product which is similar to a soft cheese of the camembert type. By using this known method, however, it is not possible to completely remove the typical aftertaste of soy beans. Other documents, such as ES2405730 and US 2017/172169 describe methods that use soy.

Moreover, soy cultivation is one of the most intensive, generally GMO, crops, making it responsible for numerous imbalances in the ecosystem. Moreover, soy proteins are one of the major allergens which must be reported on the labeling of food products.

Thus, document WO 2018/115597 describes a fresh product produced by fermentation on the basis of plant proteins and essentially soy-free. Two particular examples of the product according to this document are given: one having a cottage cheese type texture and a second similar to a solid cheese able to be sliced. Conversely, the document proposes the use of a coagulant enzyme, i.e. transglutaminase, to facilitate precipitation and to make it possible to obtain the desired texture. Thus, the intermediate product obtained is either cut to form granules (cottage cheese) or condensed and compressed (solid cheese able to be sliced). The use of an enzyme involves a step of inactivating same so that the product can undergo a further heating step after fermentation, which makes the production method complex. Moreover, this document makes no mention of soft cheese equivalents.

There is therefore a need to find other raw materials of plant origin to allow the preparation of soft cheese equivalents.

There is therefore especially a need to find other raw materials of plant origin to allow the preparation of soy-free soft cheese equivalents.

Another solution was to manufacture such cheese equivalents from nut milk, such as for example the cashew-based products marketed by the company Petit Veganne. Document WO2014/110540 relates to methods and compositions for producing non-dairy milk and cheese products as an alternative to dairy products intended for human consumption. In its example 20, this document describes a plant-based soft cheese equivalent based on nuts such as macadamia and almonds. However, such a solution has several disadvantages. On the one hand, the raw material is very expensive, thus making the finished product unaffordable. This raw material is also cultured in countries far away from the main countries where plant-based cheese alternatives are consumed, which raises environmental concerns. On the other hand, this same raw material is not available in very large amounts, thus limiting the possibility of producing plant-based alternatives on an industrial scale.

### Technical Problem

These known solutions do not make it possible to obtain products having a texture similar to that of milk-based cheese while ensuring that the method to obtain them can be industrialized on a large scale. There is therefore a need to find raw materials that make it possible to ensure large-scale production of plant-based alternatives to soft cheeses, while obtaining products that have a texture and a taste that are similar to those of the reference dairy product.

The invention improves the situation. Especially, the invention can make it possible to provide soft cheese equivalents, which may have a short ingredient list, simplifying the implementation methods and also satisfying the current expectations of consumers.

### DISCLOSURE OF THE INVENTION

According to a first aspect, a method is proposed for producing a soft cheese equivalent, preferably ripened, said method comprising the steps of:
providing a legume milk having a solids content comprised between 15% and 45%, advantageously between 20% and 40%, preferentially between 25% and 35%,
adding at least one acidifying ferment,
fermenting the legume milk comprising said at least one acidifying ferment, said legume milk comprising, by dry weight:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight;
from 25 to 75% by dry weight of fat, preferably from 35 to 65%, preferentially from 45% to 60% with respect to the total dry weight,
from 0 to 5% by dry weight of sugars, preferably from 0 to 3%, preferentially from 0.5% to 2% with respect to the total dry weight.

According to another aspect, the invention proposes a use of a liquid composition for preparing a soft cheese equivalent, said composition comprising a solids content comprised between 15% and 45%, advantageously between 20% and 40%, preferentially between 25% and 35%, and:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight,
from 25 to 75% by dry weight of fat, advantageously from 35 to 60%, preferentially from 40 to 55% with respect to the total dry weight,
from 0 to 5% by dry weight of sugars, advantageously from 0 to 3%, preferentially from 0.5 to 2% with respect to the total dry weight.

According to another aspect, the present invention relates to a dry food composition intended to be reconstituted to form a legume milk, said dry composition comprising, by dry weight:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight of the dry composition,
from 25 to 75% by dry weight of fat, preferably from 35 to 65%, preferentially from 45% to 60% with respect to the total dry weight of the dry composition,
from 0 to 5% by dry weight of sugars, preferably from 0 to 3%, preferentially from 0.5% to 2% with respect to the total dry weight of the dry composition.

According to another aspect, the present invention relates to a soft cheese equivalent comprising:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight and
from 25 to 75% by dry weight of fat, advantageously from 35 to 65%, preferentially from 45% to 60% with respect to the total dry weight, said equivalent having a firmness with a value comprised between 5 and 100 N, preferably between 10 and 70 N, preferably between 15 and 35 N.

Preferably, said equivalent is obtained by a method according to the first aspect.

The features disclosed in the following paragraphs may optionally be implemented. They may be implemented independently of one another or in combination with one another.

### DETAILED DESCRIPTION OF THE INVENTION

According to a first aspect, the invention relates to a method for producing a soft cheese equivalent, preferably ripened, said method comprising the steps of:
providing a legume milk having a solids content comprised between 15% and 45%, advantageously between 20% and 40%, preferentially between 25% and 35%,
adding at least one acidifying ferment,
fermenting the legume milk comprising said at least one acidifying ferment, said legume milk comprising, by dry weight:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight;
from 25 to 75% by dry weight of fat, preferably from 35 to 65%, preferentially from 45% to 60% with respect to the total dry weight,
from 0 to 5% by dry weight of sugars, preferably from 0 to 3%, preferentially from 0.5% to 2% with respect to the total dry weight.

One advantage of this method corresponds to the fact that the method according to the invention requires a small number of ingredients to prepare the soft cheese equivalent. Advantageously, the method according to the invention does not involve the use of a texturing agent, nor of coagulating or gelling enzyme, for example transglutaminase or any other enzyme of similar function, nor of a coagulating salt such as calcium chloride, magnesium sulfate or magnesium chloride. This is advantageous because most of the transglutaminases available contain sodium caseinate, which itself is a dairy product and is therefore not preferred.

By reducing the number of necessary ingredients, this makes it possible to reduce the risk of interaction between the various ingredients, the number of steps of the method and to improve the ease of implementing it. For example, the presence of a legume protein or a mixture of legume proteins makes it possible to avoid having to add emulsifiers, such as lecithin, since this protein itself acts as an emulsifier.

According to one embodiment, the legume milk is obtained by hydrating the solids consisting of legume proteins, NaCl salt and sugars, if the latter are present.

Preferably, the provided legume milk is prepared by hydrating the proteins, optionally adding the NaCl salt and/or sugars, adding the fat and creating an emulsion forming the legume milk.

Preferably, the provided legume milk is prepared by hydrating the proteins, adding the NaCl salt and optionally sugars, adding the fat and creating an emulsion forming the legume milk.

The legume milk can be prepared by the known methods and more precisely as disclosed in the procedure disclosed hereinafter.

Preferably, the provided legume milk is prepared by hydrating the proteins, optionally adding the NaCl salt and/or sugars, adding the fat and creating an emulsion forming the legume milk. The proteins can be hydrated by placing the proteins in water, preferentially heating the water beforehand. The hydration can vary from 1 to 60 minutes. The water temperature can range from 40 to 70° C. The fat can be mixed with the water and the proteins, optionally after having heated it beforehand. The temperature of the fat may range from 10 to 70° C. The emulsion can be done by known methods for producing emulsions, generally by shear mixing the constituents of the emulsion. The mixing can be very quick, ranging from 1 second to 20 minutes. Preferably, the preparation of the legume milk comprises a heat treatment step, for example a pasteurization step. The heat treatment step can range from a few seconds to several minutes, for example from 5 seconds to 60 minutes, at a temperature ranging from 60 to 150° C.

Preferably, the acidifying ferment is selected from lactic ferments, thermophilic ferments or mesophilic ferments or a mixture thereof. Examples of ferments are: Bifidobacterium, Lactobacillus delbruekii subsp. bulgaricus, Streptococcus thermophilus, Lactococcus lactis subsp. cremoris, Lactobacillus Lactococcus lactis subsp. lactis, Leuconostoc, Lactobacillus helveticus, Lactobacillus plantarum or Pediococcus pentasaceus.

Preferably, the fermentation step is carried out at a temperature ranging from 20° C. to 45° C. When thermophilic ferments are used, the fermentation step is carried out preferably at a temperature ranging from 38 to 45° C. When mesophilic ferments are used, the fermentation step is carried out preferably at a temperature ranging from 20 to 37° C. When a mixture of thermophilic and mesophilic ferments is used, a skilled person will know how to determine the temperature as a function of the selected ferments.

According to one embodiment, the fermentation step takes place in the absence of rennet, or even any enzyme likely to coagulate the proteins. Preferably, the fermentation step is stopped when the pH of the intermediate composition is between 4.5 and 5.5, preferably between 4.7 and 5.1.

The method of the invention may further comprise a molding step for forming the cheese equivalent. This step may, according to a first variant, be carried out by molding the seeded legume milk before fermentation. According to a second variant, the fermented preparation is roughly chopped after fermentation and then molded.

Preferably, the method further comprises an additional concentration step after the fermentation step. For example, this concentration step can be carried out by draining, centrifuging or any other technique that a skilled person will know how to choose depending on their needs. The use of such a step makes it possible to increase the solids content in the final product obtained.

For example, when the concentration step is carried out by draining, perforated molds for draining or draining bags are used. The molds used are those of the conventional type used in the cheese industry. The draining step may last from 12 hours to 10 days, for example from 1 to 5 days.

The cheese equivalent is then generally removed from the mold.

Preferably, a step of drying the cheese is carried out after this step of removing from the mold, generally for a period of 1 to 2 hours.

According to one embodiment, a step of salting can be performed on the surface of the intermediate product obtained after the fermentation step or else after the concentration step if the latter takes place.

Preferably, the method further comprises a ripening step. The equivalent thus obtained will be a ripened soft cheese equivalent.

Preferably, the ripening is carried out with at least one ripening ferment, for example such as Penicillium camemberti and/or Geotrichum candidum.

Preferably, the ripening ferments used have a low lipolysis power, in order to limit excessive development of sharp or bitter flavors.

The cheese equivalent obtained by the method according to the invention is a soft cheese equivalent, ripened or not, such as for example a camembert, brie or coulommiers equivalent or else an equivalent of washed rind cheeses such as Langres, Epoisses, Maroilles or Munster.

According to one embodiment, the ripening ferments are added by spraying the cheese, for example cheese obtained after the fermentation or drying step. According to an alternative or complementary embodiment, the ripening ferments are added internally from the start, preferably, after the pasteurization step, if the latter is present.

According to one embodiment, the ripening step is carried out at a temperature between 5 and 20° C. at a relative humidity of 90 to 99%. A skilled person will know how to choose the ripening duration and process according to the desired cheese specialty equivalent. For example, the ripening may take between 3 and 60 days, for example between 5 and 45 days, with turning over.

The method may further comprise a step of pasteurizing the legume milk before the step of adding at least one acidifying ferment.

This makes it possible to significantly reduce the number of microorganisms present in the milk without however altering the proteins.

According to one embodiment, the pasteurization step can be carried out at a temperature between 70 and 97° C. and for a period comprised between 5 seconds and 10 minutes. The time-temperature pair can be adjusted by a skilled person as a function of the desired pasteurizing value. For example, pasteurization can be carried out at 95° C. for 5 minutes.

The legume protein or proteins may be provided in the form of a solution, dispersion or suspension or in solid form, in particular in powder form.

The milk comprising at least one legume protein used according to the invention may advantageously have a total protein content (N x 6.25), of at least 25% by weight of dry product. Preferably, in the context of the present invention, a milk having a protein content comprised between 25% and 75% by weight of dry product is used, preferably between 30% and 60%, even more preferentially between 35% and 55%. The total protein content is measured by assaying the soluble nitrogen fraction contained in the sample according to the Kjeldahl method. Then, the total protein content is obtained by multiplying the nitrogen content expressed as a percentage by weight of dry product by the factor 6.25.

Furthermore, said milk comprising at least one legume protein may have a soluble protein content, expressed according to a test disclosed hereunder for measuring the water solubility of proteins, comprised between 20% and 99%. Preferably, in the context of the present invention, a composition having a high level of soluble proteins comprised between 35% and 90%, even more preferentially between 40% and 80%, and in particular between 40% and 70%, for example between 40% and 55%, is used.

To determine the level of soluble proteins, the soluble protein content is measured in water with the pH adjusted to 7.5+/−0.1 by means of a solution of HCl or NaOH, by a method of dispersion of a sample in distilled water, centrifugation and analysis of the supernatant. 200.0 g of distilled water at 20° C.+/−2° C. are added to a 400 ml beaker, and the whole is placed under magnetic stirring (magnetic bar and rotation at 200 rpm). Exactly 5 g of the sample to be analyzed are added. This is stirred during 30 min, and centrifuged during 15 min at 4000 rpm. The method for determining nitrogen according to the previously disclosed method is carried out on the supernatant. The soluble protein content thus corresponds to the mass ratio of soluble proteins to the solids of the test specimen.

The milk comprising at least one legume protein preferably has more than 50%, more preferentially more than 60%, even more preferentially more than 70%, even more preferentially more than 80%, and in particular more than 90% of proteins of more than 1000 Da. The molecular weight of the protein can be determined according to the protocol disclosed in document EP1909593 B1 in paragraphs [0056]-[0065].

Furthermore, these compositions comprising at least one legume protein preferably have a molecular weight distribution profile which consists of:
1% to 8%, preferably 1.5% to 4%, and even more preferentially 1.5% to 3%, of proteins of more than 100,000 Da,
20% to 55%, preferably 25% to 55%, of proteins of more than 15,000 Da and at most 100,000 Da,
15% to 30% of proteins of more than 5,000 Da and at most 15,000 Da,
and from 25% to 55%, preferably from 25% to 50%, and even more preferentially from 25% to 45% of proteins of at most 5,000 Da.

The legume protein may be selected from the group consisting of legume protein concentrate and legume protein isolate. The legume protein concentrates and isolates are defined with respect to their protein content (cf. the review of J. GUEGUEN of 1983 in “Proceedings of European congress on plant proteins for human food” (3-4) pages 267-304):
legume protein concentrates are disclosed as having a total protein content of 60% to 75% on dry basis, and
legume protein isolates are disclosed as having a total protein content of 75% to 90% on dry basis, the protein contents being measured by the Dumas method, the nitrogen content being multiplied by the factor 6.25.

Preferably, the legume protein or proteins have a degree of hydrolysis of less than 6, preferably ranging from 3.5 to 5.0.

### Measurement of DH (Degree of Hydrolysis)

This measurement is based on the method for determining the amino nitrogen on proteins and protein isolates according to the invention by the MEGAZYME kit (reference K-PANOPA) and the calculation of the degree of hydrolysis.

Principle: the “amino nitrogen” groups of the free amino acids in the sample react with the N-acetyl-L-cysteine and o-phthalaldehyde (OPA) to form isoindole derivatives. The amount of isoindole formed during this reaction is stoichiometric with the amount of free amino nitrogen. It is the isoindole derivative which is measured by the increase in absorbance at 340 nm.

### Procedure

A test specimen P*, exactly weighed, of the sample to be analyzed is introduced into a 100 ml beaker. (This test specimen will be from 0.5 to 5.0 g based on the amino nitrogen content of the sample.)

Add approximately 50 ml of distilled water, homogenize and decant into a 100 ml volumetric flask, add 5 ml of 20% SDS and complete the volume with distilled water; stir for 15 minutes on the magnetic stirrer at 1000 rpm.

Dissolve 1 tablet from bottle 1 of the Megazyme kit in 3 ml of distilled water and stir until it is completely dissolved. Use one tablet per test.

This solution no. 1 is prepared immediately before use.

The reaction is done directly in the spectrophotometer cuvettes.

Blank: introduce 3.00 ml of solution no. 1 and 50 ml of distilled water.

Standard: introduce 3.00 ml of solution no. 1 and 50 ml from bottle 3 of the Megazyme kit.

Sample: introduce 3.00 ml of solution no. 1 and 50 ml of the sample preparation.

Mix the cuvettes and read the measurements of absorbance (A1) of the solutions after approximately 2 min in the spectrophotometer at 340 nm (spectrophotometer equipped with cuvettes with 1.0 cm of optical path, able to measure at a wavelength of 340 nm, and verified according to the procedure disclosed in the related manufacturer's technical manual).

Then initiate the reactions immediately by adding 100 ml of the OPA solution from bottle 2 of the Megazyme kit into each spectrophotometer cuvette.

Mix the cuvettes and place them in darkness for approximately 20 minutes.

Then read the measurements of absorbance of the blank, the standard and the sample in the spectrophotometer at 340 nm.

### Calculation Mode

The free amino nitrogen content, expressed as percentage by weight as such, is given by the following formula:

$$\begin{matrix}[ {NH}_{2} \% raw ] = \frac{( Δ \text{?} - Δ \text{?} ) \times 3 , 15 \times 14 , 01 \times V \times 100}{6803 \times 0.05 \times 1000 \times m} \\ = \frac{( Δ \text{?} - Δ \text{?} ) \times 12.974 \times V}{m \times 1000}\end{matrix}$$

$$\text{?} \text{indicates text missing or illegible when filed}$$

wherein:
ΔA=A2−A1
V=volume of the flask
m=weight of the test specimen in g
and 6803=extinction coefficient of the isoindole derivative at 340 nm (in L·mol-1·cm-1).
14.01=molar mass of the nitrogen (in g·mol-1)
3.15=final volume in the cuvette (in ml) 0.05=test sample in the cuvette (in ml)

The degree of hydrolysis (DH) is given by the following formula:

$$DH = \frac{Amino nitrogen ( \% ) \times 100}{Protein nitrogen ( \% )}$$

wherein the protein nitrogen is determined according to the DUMAS method according to standard ISO 16634.

According to an alternative embodiment, the legume protein contained in the milk may also be a “legume protein hydrolysate”. legume protein hydrolysates are defined as preparations obtained by enzymatic hydrolysis, by chemical route, or by the two routes simultaneously or successively, of legume proteins. The protein hydrolysates include a higher proportion of peptides of different sizes and free amino acids than the original composition. This hydrolysis may have an impact on the solubility of the proteins. Enzymatic and/or chemical hydrolysis is for example disclosed in patent application WO 2008/001183. Preferably, the protein hydrolysis is not complete, that is to say, it does not result in a composition comprising only or substantially amino acids and small peptides (of 2 to 4 amino acids). The preferred hydrolysates comprise more than 50%, more preferentially more than 60%, even more preferentially more than 70%, even more preferentially more than 80%, and in particular more than 90% of proteins and polypeptides of more than 500 Da.

Methods for preparing protein hydrolysates are well known to a person skilled in the art and can for example comprise the following steps: dispersing the proteins in water to obtain a suspension, hydrolyzing this suspension by the selected treatment. Most often, it will be an enzymatic treatment combining a mixture of different proteases, optionally followed by a heat treatment intended to inactivate the still-active enzymes. The resulting solution can then be filtered through one or more membranes in order to separate the insoluble compounds, possibly the residual enzyme and the high molecular weight peptides (greater than 10,000 daltons).

Preferably, the legume protein or proteins have a protein content expressed by dry weight of at least 80%, preferably at least 85%.

Said protein or proteins are selected from the proteins derived from pea, faba bean, chickpea, lentil, lupin or mung bean. Preferably, said protein or proteins are selected from the proteins derived from pea or faba bean. Even more preferably, said protein or proteins are selected from pea proteins.

An example of pea protein isolate that can be used in the method according to the invention is sold under the trade name NUTRALYS® F85F by Roquette. Its degree of hydrolysis DH is between 4-5. Its total protein content is between 80-85%.

Thus, preferably, the legume protein is a pea protein. Alternatively or additionally, the legume protein is a faba bean protein.

The gelling properties of pea protein make it possible to obtain a product close to the expected texture: the product can be removed from the mold and sliced. Without being bound to a particular theory, the gelling is generally explained by protein aggregation, which may be more or less degraded, by disulfide bridges, hydrogen bonds and/or hydrophobic interactions: a three-dimensional network is therefore formed.

The term “pea” is considered herein in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The term “peas” in the present application includes pea varieties belonging to the Pisum genus and more particularly to the species sativum and aestivum.

Said mutant varieties are especially those called “r mutants”, “rb mutants”, “rug3 mutants”, “rug4 mutants”, “rug5 mutants” and “lam mutants” as disclosed in the article by C-L HEYDLEY et al., entitled “Developing novel pea starches”, Proceedings of the Symposium of the Industrial Biochemistry and Biotechnology Group of the Biochemical Society, 1996, pages 77-87.

Even more preferentially, said legume protein is derived from smooth pea.

Like all legume proteins, pea proteins consist of three main classes of proteins: globulins, albumins and so-called insoluble proteins.

The interest of pea proteins also lies in their nutritional quality and their low cost, which makes them an economical functional ingredient.

In addition, pea proteins favorably participate in sustainable development and their carbon impact is very positive. Indeed, pea cultivation is respectful of the environment and does not require nitrogen fertilizers, since peas fix nitrogen from the air.

legume milk comprises from 0 to 5% by dry weight of sugars, preferably from 0 to 3%, preferentially from 0.5% to 2% with respect to the total dry weight of the dry composition.

Preferably, the sugars are selected from dextrose or glucose, sucrose, lactose, or any other sugar fermentable by the acidifying ferments or a mixture thereof.

legume milk comprises from 25 to 75% by dry weight of fat, preferably from 35 to 65%, preferentially from 45% to 60% with respect to the total dry weight.

Preferably, the fat is selected from solid and liquid vegetable fats or a mixture thereof. For example, the fat is selected from solid fats such as coconut oil, palm oil, palm kernel, shea oil, cocoa butter, or from liquid fats, such as sunflower oil, rapeseed oil, fat from microalgae such as ARA and DHA, or any mixture of solid and/or liquid oils.

According to one embodiment, the fat has a melting point of at least 15° C., more preferably at least 20° C. An example of such a fat is coconut oil, the melting point of which is around 25° C.

According to one embodiment, the fat has a melting point of less than −10° C., preferably less than −15° C. Examples of such a fat are sunflower and rapeseed oil, which have a melting point of around −15/−20° C. and −10° C., respectively.

The legume milk useful for the invention may further comprise another source of plant proteins, used for example for its complementarity with legume proteins, or more broadly another plant base, such as oat syrup, coconut milk, oat milk, NaCl salt, one or more flavorings and colorants, nutritional fibers and/or a source of minerals, especially a source of calcium to nutritionally supplement said milk. According to the method of the invention, the addition of coagulating salts is not necessary for obtaining the soft cheese texture. Preferably, the legume milk comprises, with respect to its dry weight, less than 5% by dry weight of coagulating salt, for example less than 1%, especially less than 0.5%. The legume milk is preferentially free of coagulating salt. The term “coagulating salt” is understood to mean a salt capable of forming at least two chemical bonds with the protein.

Thus, preferably, the mineral sources are salts other than the soluble coagulant salts and are insoluble mineral salts. The coagulant salts most commonly used are magnesium chloride and calcium chloride. By way of example of an insoluble calcium salt, it may be selected from calcium carbonate, calcium citrate tetrahydrate, calcium glycerophosphate, calcium phosphate, tricalcium phosphate, calcium dihydrogen pyrophosphate, calcium sulfate, calcium acetate monohydrate.

Advantageously, the legume milk is free of texturing agent. More particularly, the legume milk free of texturing agent comprises a legume protein having a degree of hydrolysis ranging from 3.5 to 5.0.

Generally, texturing agents are used in plant-based cheese equivalents since proteins and lipids do not make it possible to provide the texture properties necessary for the composition forming the equivalent. The term “texturing agent” is understood to mean, according to the present invention, an additional polysaccharide capable of thickening or gelling the composition in which it is comprised. Such an additional polysaccharide may especially be a starch, an alginate, a galactan, a glucomannan or a galactomannan. According to a preferred embodiment, the legume milk comprises, with respect to its dry weight, less than 5% by dry weight of additional polysaccharide, for example less than 1%, especially less than 0.5%. The legume milk is preferentially free of texturing agent.

More particularly, the legume milk may be free of a texturing agent, a coagulating or gelling enzyme, for example transglutaminase or any other enzyme having a similar function and/or a coagulating salt such as calcium chloride, magnesium sulfate or magnesium chloride.

According to another aspect, the present invention relates to the use of a liquid composition for preparing a soft cheese equivalent, said composition comprising a solids content comprised between 15% and 45%, advantageously between 20% and 40%, preferentially between 25% and 35%, and:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight,
from 25 to 75% by dry weight of fat, advantageously from 35 to 65%, preferentially from 45% to 60% with respect to the total dry weight,
from 0 to 5% by dry weight of sugars, advantageously from 0 to 3%, preferentially from 0.5 to 2% with respect to the total dry weight.

Advantageously, the legume milk is free of texturing agent.

More particularly, the legume milk may be free of a texturing agent, a coagulating or gelling enzyme, for example transglutaminase or any other enzyme having a similar function and/or a coagulating salt such as calcium chloride, magnesium sulfate or magnesium chloride.

Preferably, the legume milk can be prepared by the known methods and more precisely as disclosed in the procedure disclosed hereinbefore.

Advantageously, the soft cheese equivalent is obtained by a method according to the first aspect.

The cheese equivalent may be a soft cheese equivalent, ripened or not, such as for example a camembert, brie or coulommiers equivalent or else an equivalent of washed rind cheeses such as Langres, Epoisses, Maroilles or Munster.

According to another aspect, the present invention relates to a dry food composition intended to be reconstituted to form a legume milk, said dry composition comprising, by dry weight:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight of the dry composition,
from 25 to 75% by dry weight of fat, preferably from 35 to 65%, preferentially from 45% to 60% with respect to the total dry weight of the dry composition,
from 0 to 5% by dry weight of sugars, preferably from 0 to 3%, preferentially from 0.5% to 2% with respect to the total dry weight of the dry composition.

Preferably, the dry composition further comprises from 0.5 to 2% by dry weight of sodium chloride with respect to the total dry weight of the dry composition.

Such a dry composition may be intended to be reconstituted by hydration in order to form a legume milk to be used in the method disclosed hereinafter.

Preferably, the legume milk can be prepared by the known methods and more precisely as disclosed in the procedure disclosed hereinbefore.

According to another aspect, the invention relates to a soft cheese equivalent comprising, by dry weight:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight of the dry composition,
from 25 to 75% by dry weight of fat, preferably from 35 to 65%, preferentially from 45% to 60% with respect to the total dry weight of the dry composition, said equivalent having a firmness with a value comprised between 5 and 100 N, for example between 10 and 70 N, especially between 15 and 35 N.

Advantageously, the equivalent has a solids content comprised between 25 and 50%, preferably between 30 and 48%, preferably between and 45%.

The equivalent may comprise residual amounts of sugars, in the case where they have not completely fermented, for example preferably from 0 to 3%, preferentially from 0.5% to 2% with respect to the total dry weight of the dry composition.

Such a cheese equivalent can be obtained according to the method disclosed hereinbefore.

The firmness is measured by penetrometry, with a cylinder punch having a diameter of 36 mm, a pre-load of 0.5 N, and a penetration to 15 mm at a speed of 100 mm/min.

The texture can be determined by a texture analyzer of the Instron® brand according to the guidelines of the manual and using the following parameters:

| Mode | Firmness measurement | |
|---|---|---|
| Pre-load | 0.5N | |
| Pre-speed | 10 | mm/min |
| Measurement speed | 100 | mm/min |
| Penetration distance | 15 | mm |

| | |
|---|---|
| Measurement probe | Compression cylinder with |
| | a diameter of 36 mm |

The cheese equivalent may be a soft cheese equivalent, ripened or not, such as for example a camembert, brie or coulommiers equivalent or else an equivalent of washed rind cheeses such as Langres, Epoisses, Maroilles or Munster.

Preferably, said cheese equivalent is obtained by the method disclosed hereinbefore.

Raw materials used
NUTRALYS® F85F pea protein isolate, marketed by ROQUETTE
Refined copra (coconut) oil, marketed by Interchimie
Fine table salt, commercially available
Thermophilic lactic ferments, for example YoFlex® YF-L02 DA, marketed by CHR HANSEN
Sucrose (for example, in the case of using YoFlex® YF-L02 DA ferments) or dextrose (for example, in the case of using XT-208 ferments)

In some examples, the following raw materials were also used:
Lightly hydrolyzed pea protein isolate, produced by ROQUETTE
Calcium chloride
CLEARGUM® MB 70, fluidized corn starch, marketed by ROQUETTE
Nu-trish® BB-12 bifidogenic ferments, marketed by CHR HANSEN (used in addition to the YoFlex® YF-L02 DA ferments)

XT-208 mesophilic lactic ferments, marketed by CHR HANSEN (used instead of YoFlex® YF-L02 DA ferments)

Ripening ferments: Geotrichum, for example Geotrichum Candidum, and/or Penicillium, for example Penicillium Camemberti.

### Procedure

The soft cheese equivalent according to the invention was prepared in the following way:
Heating the fat to 55° C.
Heating the water to 55° C.
In a mixing apparatus (HOTMIX Pro-Creative) kept at 55° C., adding the plant proteins to the water and stirring for 20 minutes at 800 rpm
Adding the other ingredients except the fat, mixing for 1 minute at 1800 rpm (at 55° C.)
Adding the fat and mixing for 5 minutes at 1800 rpm (at 55° C.)
Applying pasteurization at 95° C. for 5 minutes (stirring at 800 rpm)
Cooling to 40° C., and then adding the acidifying ferment. Mixing for 20 seconds at 800 rpm to disperse the ferment
Molding the seeded preparation in a camembert mold
Leaving to ferment at 40° C. until the desired pH (4.9) is reached
Optionally (example 5 only), draining the product using a perforated mold in the molding step. Placing the perforated mold on a grid and left to drain for 5 days at 4° C.
Removing the cheese equivalent from the mold

### EXAMPLES

### Example 1—Influence of the Addition of the Texturing Agent

TABLE 1
Composition used (% ingredient/total weight milk)

| | | |
|---|---|---|
| % NUTRALYS ® F85F | 12.7 | 12.7 |
| % refined copra oil | 16.2 | 16.2 |
| % salt | 1.0 | 1.0 |
| % CLEARGUM ® MB 70 starch | 8.0 | 0.0 |
| % sucrose | 0.6 | 0.6 |
| % water | 61.5 | 69.5 |
| YoFlex YF-L02 lactic ferments | qs | qs |
| Total | 100.0 | 100.0 |

Final composition

| | | |
|---|---|---|
| % fat (dry/total weight milk) | 17.3 | 17.3 |
| % fat (dry fat/TOTAL dry) | 48 | 58 |
| % proteins (dry/total weight milk) | 10 | 10 |
| % proteins (dry/TOTAL dry) | 28 | 33 |
| % solids | 36 | 30 |
| Texture before fermentation | Thick, gelled | Thick, smooth |
| Texture after cooling (4° C.) | Firm gel, dry | Firm gel |

The addition of a fluidized starch gave a thick, gelled product but caused a loss of the smooth aspect of the pea proteins. This type of amylose-rich starch in theory gives a short texture and a firm gel after 4 to 12 hours cold. The fact that it is fluidized makes it possible to use it with a high percentage by having limited viscosity when hot, and the supply of a gelled texture after cooling. Surprisingly, the cheese which does not comprise any texturing agent has even better texture than the one that does comprise it. Thus, according to this alternative, the Applicant has succeeded, by using a legume milk with high solids content, in producing a cheese having a texture similar to that of a camembert. The cheese has a short list of ingredients, and requires neither the use of a texturing agent, nor the use of a coagulating salt or of an enzyme such as rennet or transglucosidase.

### Example 2—Influence of the Degree of Hydrolysis of the Pea Protein

TABLE 2
Composition used (% ingredient/total weight milk)

| | | | |
|---|---|---|---|
| % NUTRALYS ® F85F | 12.7 | 0.0 | 0.0 |
| % lightly hydrolyzed pea | 0.0 | 12.7 | 20.0 |
| protein | | | |
| % refined copra oil | 16.2 | 16.2 | 16.2 |
| % salt | 1.0 | 1.0 | 1.0 |
| % sucrose | 0.6 | 0.6 | 0.6 |
| YoFlex YF-L02 lactic | qs | qs | qs |
| ferments | | | |
| % water | 69.5 | 69.5 | 62.2 |
| Total | 100.0 | 100.0 | 100.0 |

Final composition

| | | | |
|---|---|---|---|
| % fat (dry/total weight milk) | 17.3 | 17.3 | 18.0 |
| % fat (dry fat/TOTAL dry) | 58 | 58 | 50.0 |
| % proteins (dry/total weight | 10 | 10 | 16.0 |
| milk) | | | |
| % proteins (dry/TOTAL dry) | 33 | 33 | 44.0 |
| % solids | 30 | 30 | 36 |
| Texture before fermentation | Thick, | Liquid | Liquid |
| | smooth | | |
| Texture after cooling (4° C.) | Firm gel | Not gelled | Not gelled |

In these recipes without an additional texturing agent, the use of a lightly hydrolyzed protein did not make it possible to obtain the desired gelling for generating a camembert-like texture. Even with isolate contents of 20%, the product remains too liquid.

### Example 3—Influence of the Addition of a Coagulating Salt

TABLE 3
Composition used (% ingredient/total weight milk)

| | | |
|---|---|---|
| % NUTRALYS ® F85F | 12.7 | 12.7 |
| % refined copra oil | 16.2 | 16.2 |
| % salt | 1.0 | 1.0 |
| % sucrose | 0.6 | 0.6 |
| % calcium chloride solution (54 | 2.38 | 0.0 |
| g/100 g) | | |
| YoFlex YF-L02 lactic ferments | qs | qs |
| % water | 67.12 | 69.5 |
| Total | 100.0 | 100.0 |

Final composition

| | | |
|---|---|---|
| % fat (dry/total weight milk) | 17.3 | 17.3 |
| % fat (dry fat/TOTAL dry) | 58.0 | 58.0 |
| % proteins (dry/total weight milk) | 10.0 | 10.0 |
| % proteins (dry/TOTAL dry) | 33.0 | 33.0 |
| % calcium chloride (dry/total | 1.18 | 0.0 |
| weight milk) | | |
| % solids | 30.0 | 30.0 |
| Texture before fermentation | Thick, matt | Thick, smooth |
| Texture after cooling (4° C.) | Soft gel | Firm gel |

A formula with CaCl₂) was produced in order to test the coagulation of the pea proteins by a coagulating salt. The presence of the salts leads to interactions with the carboxylate groups on the surface of the protein aggregates, which induces partial or total screening of the negative charges. Adding divalent cations, such as those of calcium, in addition to the fact that they generate a higher ionic strength at lower concentrations than monovalent ions, allows the formation of salt bridges between aggregates that result in the three-dimensional protein network. The result obtained after fermentation is not completely satisfactory, the texture is much softer and the taste is much too salty. Surprisingly, while the formula with CaCl₂) was thick and firm in the non-fermented and cooled product, the texture obtained after fermentation with this recipe is much softer and less gelled than the texture obtained with the calcium-free recipe. Thus, the recipe and the method used in the invention make it possible to obtain a texture similar to that of a soft cheese, without requiring the use of a coagulating salt.

### Example 4—Influence of the Protein Concentration

TABLE 4
Milk composition and final composition
Composition used (% ingredient/total weight milk)

| | | | | | |
|---|---|---|---|---|---|
| % | 20.0 | 17.8 | 15.2 | 12.7 | 12.7 |
| NUTRALYS | | | | | |
| F85F | | | | | |
| % refined | 16.2 | 16.2 | 16.2 | 16.2 | 16.2 |
| copra oil | | | | | |
| % salt | 1.0 | 1.0 | 1.0 | 1.0 | 1.0 |
| % sucrose | 0.6 | 0.6 | 0.6 | 0.6 | 0 |
| % dextrose | 0 | 0 | 0 | 0 | 0.6 |
| YoFlex YF- | qs | qs | qs | qs | |
| L02 lactic | | | | | |
| ferments | | | | | |
| XT-208 lactic | | | | | qs* |
| ferments | | | | | |
| % water | 62.2 | 64.4 | 67.0 | 69.5 | 69.5 |
| Total | 100.0 | 100.0 | 100.0 | 100.0 | 100.0 |

Final composition

| | | | | | |
|---|---|---|---|---|---|
| % fat | 18.0 | 17.8 | 17.6 | 17.3 | 17.3 |
| (dry/total milk | | | | | |
| weight) | | | | | |
| % fat (dry | 50.0 | 52.0 | 55.0 | 59.0 | 59.0 |
| fat/dry) | | | | | |
| % proteins | 16 | 14 | 12 | 10 | 10 |
| (dry/total | | | | | |
| weight milk) | | | | | |
| % proteins | 44 | 41 | 38 | 34 | 34 |
| (dry | | | | | |
| protein/dry) | | | | | |
| % solids | 36 | 34 | 32 | 29 | 29 |
| Texture | Very thick, very | Very thick, | Thick, | Thick, | Thick, |
| before | difficult to mold | difficult to | smooth | smooth | smooth |
| fermentation | | mold | | | |
| Texture after | Excessively firm | Very firm | Firm gel | Firm gel, | Firm gel, |
| fermentation | gel, too dry | gel | | smooth | smooth |
| and cooling | | | | | |
| (4° C.) | | | | | |

*In the case of the XT-208 mesophilic ferment, the fermentation temperature during the method is not 40° C. but 30° C.

A pea protein concentration comprised between 10 and 16% with respect to the total mass of the milk makes it possible to achieve gelling. However, above a pea protein concentration of 14% with respect to the total mass of the milk, it appears that the composition obtained has a greater viscosity and a greater buffering power, which may cause a significant slowing down of the fermentation. It was also observed that, using the mesophilic ferment of this test, the taste of the camembert equivalent is less vegetable and closer to a dairy cheese.

### Example 5—Influence of the Solids Content and Draining

TABLE 5
Composition used (% ingredient/total weight milk)

| % | 4.65 | 8.68 | 17.8 | 12.7 | 12.7 | 12.7 | 15.2 |
|---|---|---|---|---|---|---|---|
| NUTRALY | | | | | | | |
| S F85F | | | | | | | |
| % refined | 5.5 | 10.85 | 16.2 | 16.2 | 16.2 | 9.0 | 16.2 |
| copra oil | | | | | | | |
| % salt | 1.0 | 1.0 | 1.0 | 1.0 | 1.0 | 1.0 | 1.0 |
| % sucrose | 0.6 | 0.6 | 0.6 | 0.6 | 0.6 | 0.6 | 0.6 |
| YoFlex YF- | qs | qs | qs | qs | — | qs | sb |
| L02 lactic | | | | | | | |
| ferments | | | | | | | |
| XT-208 | — | — | — | — | qs | | |
| lactic | | | | | | | |
| ferments | | | | | | | |
| % water | 88.85 | 79.47 | 65.0 | 70.1 | 70.1 | 77.3 | 67.6 |
| Total | 100.00 | 100.00 | 100.00 | 100.00 | 100.00 | 100.00 | 100.00 |
| | Final Composition | | | | | | |
| % fat | 5.9 | 11.6 | 17.8 | 17.3 | 17.3 | 10.9 | 17.6 |
| (dry/total | | | | | | | |
| weight | | | | | | | |
| milk) | | | | | | | |
| % fat | 54 | 58 | 52 | 58 | 58 | 50 | 55 |
| (dry/dry) | | | | | | | |
| % proteins | 3.7 | 6.8 | 14.0 | 10.0 | 10.0 | 10.0 | 12.0 |
| (dry/total | | | | | | | |
| weight | | | | | | | |
| milk) | | | | | | | |
| % proteins | 34 | 34 | 41 | 33 | 33 | 50 | 38 |
| (dry/dry) | | | | | | | |
| % milk | 11 | 20 | 34 | 29 | 29 | 22 | 32 |
| solids | | | | | | | |
| % solids of | ND | 221 | 411 | 402 | 382 | 301 | 401 |
| the | | | | | | | |
| fermented | | | | | | | |
| composition | | | | | | | |
| after | | | | | | | |
| draining | | | | | | | |
| % proteins | ND | ND | ND | 14.7 | 13.9 | ND | ND |
| of the | | | | | | | |
| fermented | | | | | | | |
| composition | | | | | | | |
| after | | | | | | | |
| draining³ | | | | | | | |
| % fat of the | ND | ND | ND | 27.0 | 22.5 | ND | ND |
| fermented | | | | | | | |
| composition | | | | | | | |
| after | | | | | | | |
| draining⁴ | | | | | | | |
| Texture | Liquid | Fat | Very | Thick, | Thick, | Thick, | Thick, |
| before | | separation | thick, | smooth | smooth | smooth | smooth |
| fermentation | | | difficult | | | | |
| | | | to | | | | |
| | | | mold | | | | |
| Texture | Soft | Firm gel | Very | Firm | Firm | Firm | Firm |
| after | gel, | | firm | gel, | gel, | gel | gel |
| fermentation | yoghurt | | gel | smooth | smooth | | |
| and | type | | | | | | |
| cooling | | | | | | | |
| (4° C.) | | | | | | | |

Final composition
¹solids estimated by weighing after 5 days of draining at 4° C., assuming that the discharged whey consists exclusively of water
²solids analyzed in an oven at 80° C., reduced pressure
³Proteins analyzed by the Dumas method
⁴Analyzed fat (analysis of total lipids)
ND: not determined
It is necessary to obtain a texture that is sufficiently thick before draining to allow water separation as well as a gelled structure.

The draining step therefore leads to increasing the solids content in the product obtained from the legume milk, thus making it possible to have a moderate viscosity at the time of preparation of the product and molding, while guaranteeing a finished product with a solids content that is high enough for an acceptable texture and preservation. It is clear that in order to obtain a firm gel, it is advisable for the milk to have a solids content of at least 15%, but less than 35%.

### Example 6—Plant-Based Ripened Soft Cheese Equivalent

### Procedure

The soft cheese equivalent according to the invention was prepared in the following way:
Heating the fat to 55° C.
Heating the water to 55° C.
In a mixing apparatus (Stephan with capacity of 15 kg) kept at 55° C., adding the plant proteins to the water and stirring for 20 to 30 minutes at medium speed
Adding the other ingredients (sugars and salt) except for the fat, mixing for 1 minute at high speed (at 55° C.)
Adding the fat and mixing for 5 minutes at high speed (at 55° C.)
Applying pasteurization at 95° C. for 5 minutes (stirring at medium speed)
Cooling to 40° C., and then adding the acidifying ferments (and, according to an alternative, the ripening ferments). Mixing for 20 seconds at medium speed to disperse the ferments
Molding the seeded preparation in a camembert mold. Leaving to ferment at 40° C. until the desired pH (4.9) is reached
Removing the cheese equivalent from the mold after 24 hours,
Drying for 1 to 2 hours in a dry atmosphere, in order to remove the surface moisture,
According to a first version, spraying the surface with a sugary solution with the ripening flora (Geotrichum candidum and Penicillium camemberti)—in a second version, this flora is added in the same amounts after pasteurization, at the same time as the acidifying ferments.
Ripening for 8 days at 10-14° C./94-96% relative humidity
Packaging and storing at 4° C.

TABLE 6
Composition used (% ingredient/total weight milk)

| | |
|---|---|
| % NUTRALYS ® F85F | 12.7 |
| % refined copra oil | 16.2 |
| % salt | 1.0 |
| % sucrose | 0.6 |
| YoFlex ® YF-L02 + Nu-trish ® BB12 | qs |
| lactic ferments | |
| % water | 69.5 |
| Total | 100.0 |

Final composition

| | |
|---|---|
| % fat (dry/total weight milk) | 17.3 |
| % fat (dry fat/TOTAL dry) | 58.0 |
| % proteins (dry/total weight milk) | 10.0 |
| % proteins (dry/TOTAL dry) | 33.0 |
| % solids | 30.0 |
| % final solids after draining | 40 |
| Texture before fermentation | Thick, smooth |
| Texture after cooling (4° C.) | Firm gel, smooth |

This test made it possible to obtain a firm and smooth product after fermentation and cooling. It is sliceable, also with a smooth edge. The taste is fresh with a slight acidity and a slight vegetable taste. Fermentation makes it possible to achieve a pH of 4.9 with an acceptable duration, of the order of 9 h.

Ripening allows a slight white fuzz to develop on the surface of the product and the modification of the flavors. It is observed that the internal addition of ripening ferments (at the same time as the acidifying ferments) makes it possible to obtain a rind that is more regular and homogeneous than spraying on the surface after drying.

1. A method for producing a soft cheese equivalent, preferably ripened, said method comprising the steps of:
providing a legume milk having a solids content comprised between 15% and 45%, advantageously between 20% and 40%, preferentially between 25% and 35%,
adding at least one acidifying ferment,
fermenting the legume milk comprising said acidifying ferment,
said legume milk comprising, by dry weight:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight;
from 25 to 75% by dry weight of fat, preferably from 35 to 65%, preferentially from 45% to 60% with respect to the total dry weight,
from 0 to 5% by dry weight of sugars, preferably from 0 to 3%, preferentially from 0.5% to 2% with respect to the total dry weight.

2. The method according to claim 1, wherein the acidifying ferment is selected from the thermophilic ferments, the mesophilic ferments or a mixture thereof.

3. The method according to claim 1, wherein it further comprises an additional concentration step after the fermentation step.

4. The method according to claim 1, wherein it further comprises a ripening step.

5. The method according to claim 4, wherein the ripening is carried out with Penicillium camemberti and/or Geotrichum candidum.

6. The method according to claim 1, wherein the legume protein has a degree of hydrolysis of less than 6, preferably ranging from 3.5 to 5.0.

7. The method according to claim 1, wherein the legume protein has a protein content expressed by dry weight of at least 80%, preferably at least 85%.

8. The method according to claim 1, wherein the legume protein is a pea protein.

9. The method according to claim 1, wherein the fat is selected from solid or liquid vegetable fats or a mixture thereof.

10. The method according to claim 1, wherein the legume milk is free of texturing agent.

11. A use of a liquid composition for preparing a soft cheese equivalent, said composition comprising a solids content comprised between 15% and 45%, advantageously between 20% and 40%, preferentially between 25% and 35%, and:
from 25% to 75%, preferably from 30% to 60%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight,
from 25 to 75% by dry weight of fat, advantageously from 35 to 65%, preferentially from 45% to 60% with respect to the total dry weight,
from 0 to 5% by dry weight of sugars, advantageously from 0 to 3%, preferentially from 0.5 to 2% with respect to the total dry weight

12. A soft cheese equivalent, comprising:
from 25% to 75%, preferably from 30% to 60′%, preferentially from 35% to 55% by dry weight of a legume protein or a mixture of legume proteins, said protein or proteins being selected from the proteins derived from pea, faba bean, chickpea, lentil, lupin or mung bean, with respect to the total dry weight and
from 25 to 75% by dry weight of fat, advantageously from 35 to 65%, preferentially from 45% to 60% with respect to the total dry weight,
said equivalent having a firmness with a value comprised between 5 and 100 N, preferably between 10 and 70 N, preferably between 15 and 35 N.

13. The equivalent according to claim 12, wherein it has a solids content comprised between 25 and 50%, preferably between 30 and 48%, preferably between 35 and 45%.
